(19) United States
(12) Patent Application Publication
(10) Pub. No.: US 2025/0230284 A1
(43) Pub. Date: Jul. 17, 2025

(54) METHOD FOR MANUFACTURING HIGH-REACTIVITY POLYPHENYLENE SULFIDE RESIN AND PRODUCT MANUFACTURED THEREBY

(71) Applicants: ZHEJIANG NHU SPECIAL MATERIALS CO., LTD., SHAOXING, ZHEJIANG PROVINCE (CN); ZHEJIANG NHU CO., LTD., SHAOXING, ZHEJIANG PROVINCE (CN)

(72) Inventors: ZHENG YANG, SHAOXING, ZHEJIANG PROVINCE (CN); HUIQIANG GUI, SHAOXING, ZHEJIANG PROVINCE (CN); HANGJUN DENG, SHAOXING, ZHEJIANG PROVINCE (CN); GUIYANG ZHOU, SHAOXING, ZHEJIANG PROVINCE (CN); JUN HU, SHAOXING, ZHEJIANG PROVINCE (CN)

(21) Appl. No.: 18/850,006

(22) PCT Filed: Oct. 10, 2023
(86) PCT No.: PCT/CN2023/123839

§ 371 Date: Sep. 23, 2024

(30) Foreign Application Priority Data
Oct. 13, 2022 (CN) 202211252507.7

(51) Int. Cl. C08G 75/0259; C08G 75/0281; C08G 75/029

(52) U.S. Cl. CPC C08G 75/0259; C08G 75/0281; C08G 75/029

(57) ABSTRACT

The present disclosure discloses a method for preparing high-activity polyphenylene sulfide (PPS) by regulating and controlling a water content in a polymerization process and a high-efficiency polyphenylene sulfide resin prepared thereby. The preparation method includes: carrying out a polycondensation reaction with sodium hydrosulfide and p-dichlorobenzene as raw materials and N-methyl-2-pyrrolidone as a solvent until a conversion rate of the p-dichlorobenzene reaches 97% or above, adding deionized water, reducing the temperature in a reactor to 250-260° C. for heat preservation for 1-3 h, and performing cooling for post-treatment; and calculated with the sodium hydrosulfide as 1.0 mol, a molar amount of the added deionized water is 1.0-2.5 mol. The method for preparing high-activity polyphenylene sulfide disclosed in the present disclosure can be simultaneously realized in a PPS polymerization process, and that is to say, an end-capping reagent is not required to be additionally added to affect the molecular weight and thermal stability of the finally prepared PPS; and activation treatment is also not required to be performed after the PPS resin is prepared to additionally increase the technological process and the production cost.

### FIELD OF TECHNOLOGY

The present disclosure relates to the technical field of polyphenylene sulfide, in particular to a method for preparing a high-reactivity polyphenylene sulfide resin by regulating and controlling a water content in a polymerization process and high-reactivity polyphenylene sulfide prepared thereby.

### BACKGROUND TECHNOLOGY

Polyphenylene sulfide (PPS) is a sixth largest engineering plastic having the advantages of high mechanical strength, high long-term use temperature, chemical resistance, excellent electrical properties, good flame retardancy, etc., and has been widely used in the fields of environmental protection, automotive electronics and electrical appliances, machinery and aerospace, etc. However, the polyphenylene sulfide has a molecular structure mainly composed of a benzene ring and sulfur in alternate arrangement, is almost free of active groups, and has poor interaction and reactivity with silane coupling agents. In order to improve the toughness and impact resistance of polyarylene sulfide, researchers usually introduce active groups to terminal groups of the polyarylene sulfide, and a most common one is carboxyl. Resins containing carboxyl can greatly improve the activity of resins and can undergo physical and chemical crosslinking with silane coupling agents, glass fibers or other fillers in extrusion modification of the resins to improve the compatibility, the toughness and the impact resistance.

In order to increase the terminal carboxyl content of PPS resins, a patent document No. JP6682793B2 discloses that a polyphenylene sulfide resin is synthesized by introducing 0.2-0.35 mol of p-chlorobenzoic acid (relative to 1 mole of a sulfur source) as an additive in a polymerization reaction. The terminal carboxyl content of the polyphenylene sulfide resin is greater than 500 μmol/g. Because an end-capping reagent is usually a single functional group molecule, introduction of the end-capping reagent in a large amount will lead to too early end-capping of the PPS and affect increase of the molecular weight of the PPS. Therefore, the number-average molecular weight of polyphenylene sulfide resins synthesized in examples of the patent document is only 5,000-6,000.

A Chinese patent document No. CN108164702A discloses that a primary product of a polyphenylene sulfide resin is obtained by carrying out a polycondensation reaction with a sulfur-containing compound, an alkaline substance and p-dichlorobenzene as raw materials and a fatty acid as a polycondensation additive and performing purification treatment, and then the primary product undergoes a reaction with a terminal group regulator containing a hydroxyaromatic thiol compound and 4-phenylthio-benzenethiol at high temperature to obtain a polyphenylene sulfide resin. The polyphenylene sulfide resin has a thermal stability index of greater than 0.95, a reactivity of greater than 2.5 and a melting temperature of 230-260° C. The scheme takes into account both the thermal stability and reactivity of the resin, but the reactivity still cannot meet requirements.

Therefore, an additional end-capping reagent is usually required to be added to achieve high-reactivity PPS with a carboxyl active terminal group, thereby increasing the cost. Moreover, because the reaction conversion rate cannot reach 100%, an impact is caused to the recovery of a post-treatment solvent. In addition, the carboxyl terminal group formed by adding the additive, such as p-chlorobenzoic acid, has lower stability than own carboxyl, leading to reduced thermal stability.

### SUMMARY OF THE INVENTION

Aiming at the above problems of the prior art, the present disclosure discloses a method for manufacturing a high-reactivity polyphenylene sulfide resin, which can be simultaneously realized in a PPS polymerization process, and that is to say, an end-capping reagent is not required to be additionally added to affect the molecular weight and thermal stability of the finally prepared PPS; and chain expansion treatment is also not required to be performed after the PPS resin is prepared to additionally increase the technological process and the production cost.

Specific technical schemes are as follows.

A method for manufacturing a high-reactivity polyphenylene sulfide resin includes: carrying out a polycondensation reaction with sodium hydrosulfide and p-dichlorobenzene as raw materials and N-methyl-2-pyrrolidone as a solvent until a conversion rate of the p-dichlorobenzene reaches 97% or above, adding deionized water, reducing the temperature in a reactor to 250-260° C. for a heat preservation reaction for 1-3 hours, and performing cooling for post-treatment;
and calculated with the content of total sulfur in the system as 1.0 mol, a molar amount of the added deionized water is 1.0-2.5 mol.

The present disclosure discloses a method for preparing high-activity polyphenylene sulfide by regulating and controlling a water content in a polymerization process. After carrying out a large number of tests, the inventor finds that when a certain amount of water is continuously added after increase of a molecular chain of the PPS is basically stopped (the conversion rate of the p-dichlorobenzene reaches 97% or above), NMP (N-methyl-2-pyrrolidone) is hydrolyzed to produce SMAB in an alkaline environment, and at a temperature of 10-20° C. (250-260° C.) higher than a precipitation temperature of a PPS resin, the SMAB can continue to react with a chloro terminal group of the PPS for a continuous reaction for 1-3 h to synthesize a large number of a PPS resin with a carboxyl terminal group. A specific reaction formula is shown as follows.

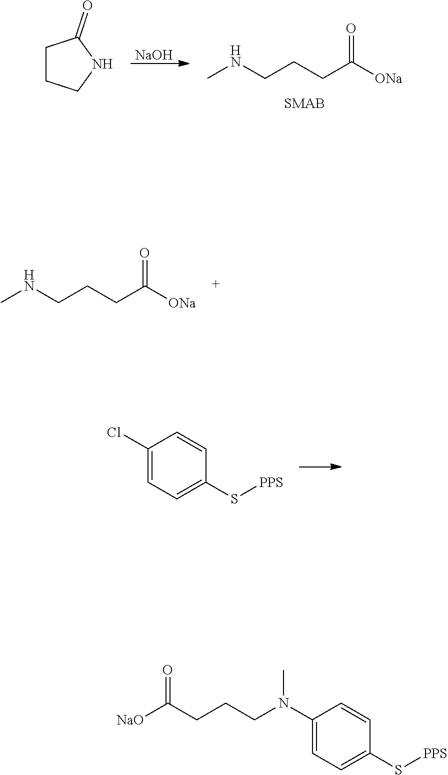

As found through tests, the preparation method has several key points. The first point is the water addition time. The water needs to be added after the increase of the molecular chain of the PPS is basically stopped. As found through tests, when the water is added in advance, such as at a polymerization stage, inconvenience will be caused to the synthesis of a large number of the PPS resin with the carboxyl terminal group. Even when the water is added after polymerization is completed and when the conversion rate of the p-dichlorobenzene does not reach 97% or above, increase of the molecular weight of the PPS resin will be stopped in advance without reaching an ideal molecular weight, and loss of the raw material PDCB (p-dichlorobenzene) will be caused. The second point is the molar ratio of the added water to a sulfur source in the system. Because the water is a poor solvent for the PPS, it is found through tests that when too much water is added, the PPS has poor solubility in NMP-H₂O, poor terminal group reactivity and activity not significantly better than that of the 1.0-2.5 mol/mol sulfur source, leading to the loss of NMP in a large amount. Moreover, the addition of a large amount of water leads to too high pressure in the reactor and increases the risk of polymerization. When too little water is added, the carboxyl terminal group generated is not enough, and the activity cannot meet requirements. Therefore, the amount of the added water is controlled to be 1.0-2.5 mol/mol of the sulfur source. The third point is that the temperature in the reactor is controlled and reduced to 250-260° C. after the water is added. As found through tests, when the temperature is greatly reduced, precipitation of the PPS resin will be caused, and the reactivity of the terminal group is not enough; and when the temperature is little reduced, too many side reactions may occur, leading to chain break and causing the risk of depolymerization of the PPS.

Preferably, the deionized water is added when the polycondensation reaction is carried out until the conversion rate of the p-dichlorobenzene reaches 99% or above. As found through tests, the high-reactivity PPS resin with a higher molecular weight can be prepared by controlling the conversion rate of the p-dichlorobenzene to 99% or above.

Preferably, the added deionized water needs to be preheated to 80-90° C. to prevent that the temperature in the reactor is reduced too fast after the addition.

Preferably, the added deionized water is 1.5-2.5 mol/mol of the sulfur source, further preferably 1.5-2.0 mol/mol of the sulfur source, more preferably 2.0 mol/mol of the sulfur source.

With continuous optimization of the molar amount of the added deionized water, the prepared PPS resin has higher reactivity and meanwhile has both excellent thermal stability and a high molecular weight.

Preferably, after the deionized water is added, the temperature in the reactor is reduced to 250-260° C. at a cooling rate of 1.0-3.0° C./min.

As found through tests, control of the cooling rate is also very important. When the temperature is reduced too slowly, the NMP will form by-products under the action of water at higher temperature and has a longer side reaction time of chain exchange with the PPS, thus breaking the molecular chain of the PPS and having the risk of depolymerization. In a water addition process, vaporization of partial water leads to increase of the pressure in the reactor and too fast decrease of the temperature, indicating that when the water is added at a too higher speed, the pressure is increased faster, a too strong impact effect is caused to the reactor itself and a sealing system of the reactor, and equipment damage is likely to be caused.

Further preferably, the temperature in the reactor is reduced to 250-260° C. at a cooling rate of 1.0-2.0° C./min.

The method for preparing high-activity polyphenylene sulfide by regulating and controlling a water content in a polymerization process disclosed in the present disclosure specifically includes:
(1) putting a sodium hydrosulfide aqueous solution, an alkali metal hydroxide aqueous solution, an optionally added additive and N-methyl-2-pyrrolidone into a reactor, performing heating to 180-200° C. for dehydration under the protection of a nitrogen atmosphere, and then performing cooling to 160-180° C.;
(2) adding p-dichlorobenzene and N-methyl-2-pyrrolidone to the reactor, performing heating to 220-240° C. to carry out a polymerization reaction first until the conversion rate of the p-dichlorobenzene reaches 85% or above, and then performing heating to 260-280° C. to carry out the polymerization reaction until the conversion rate of the p-dichlorobenzene reaches 97% or above, preferably until the conversion rate of the p-dichlorobenzene reaches 99% or above; and
(3) adding deionized water to the reactor, reducing the temperature in the reactor to 250-260° C. for a heat preservation reaction for 1-3 hours, performing cooling to 100-150° C. to obtain a PPS reaction solution, and then performing post-treatment to obtain high-activity polyphenylene sulfide.

In step (1):
a concentration of the sodium hydrosulfide aqueous solution is 40-55 wt %, and a concentration of the alkali metal hydroxide aqueous solution is 45-55 wt %;
calculated with NaHS in the sodium hydrosulfide aqueous solution as 1.0 mol, a molar amount of an alkali metal hydroxide is 1.0-1.4 mol;
and preferably, the alkali metal hydroxide aqueous solution is selected from a sodium hydroxide aqueous solution.

The optionally added additive is selected from a C₅-C₆ fatty acid salt and added in the form of a 35-45 wt % aqueous solution, and calculated with NaHS in the sodium hydrosulfide aqueous solution as 1.0 mol, a molar amount of the added additive is 0.1-0.5 mol;
and preferably, the C₅-C₆ fatty acid salt is selected from one or more of sodium 2-ethylbutyrate, sodium valerate, sodium isovalerate, and sodium caproate.

Calculated with NaHS in the sodium hydrosulfide aqueous solution as 1.0 mol, a molar amount of the added N-methyl-2-pyrrolidone is 2.4-3.0 mol.

Preferably, in step (1):
the heating is performed to 180-200° C. for the dehydration at a heating rate of 0.7-1.5° C./min;
and the dehydration is performed until a molar content ratio of water to sulfur in the system is (0.9-1.2):1.

In step (2):

Calculated with the content of total sulfur in the system as 1.0 mol, a molar amount of the p-dichlorobenzene is 0.99-1.05 mol;
after the N-methyl-2-pyrrolidone is added, calculated with the content of total sulfur in the system as 1.0 mol, a molar amount of the N-methyl-2-pyrrolidone in the system is 3.5-4.5 mol;
and preferably,
the heating is performed to 220-240° C. at a heating rate of 0.6-1.5° C./min to carry out the polymerization reaction first, and then the heating is performed to 260-280° C. at a heating rate of 0.5-1.0° C./min to carry out the polymerization reaction.

In step (3):

After the heat preservation, the particle size of prepared PPS particles can be regulated and controlled by controlling the temperature after the cooling. Preferably, the cooling is controlled to 110-150° C.

The post-treatment includes filtering, washing, and drying.

The filtering includes filtering the obtained PPS reaction solution through a 150-mesh screen.

The washing includes performing rinsing with NMP heated to 100-150° C. at the same mass as a filter cake obtained after the filtering, followed by spin-drying; then performing rinsing with a diluted hydrochloric acid solution at the same mass as the filter cake, followed by spin-drying; and finally, performing washing with deionized water at 70-100° C. for several times until chloride ions are qualified.

Filtrates produced in washing processes are combined and collected, first subjected to azeotropic distillation to separate the additive, then subjected to distillation to remove the water, and finally subjected to reduced pressure distillation to recover the solvent NMP. A residue produced by the distillation can be disposed by incineration.

In step (3):
preferably, calculated with the content of total sulfur in the system as 1.0 mol, a molar amount of the added deionized water is 1.5-2.5 mol;
and after the temperature in the reactor is reduced to 250-260° C. at a cooling rate of 1.0-3.0° C./min, the heat preservation reaction is carried out for 1-3 hours.

The present disclosure further discloses a high-reactivity polyphenylene sulfide resin prepared by the method. The high-reactivity polyphenylene sulfide resin has a carboxyl content of equal to or greater than 100 mmol/kg. Preferably, the high-reactivity polyphenylene sulfide resin has the carboxyl content of 150-250 mmol/kg.

Compared with the prior art, the present disclosure has the following beneficial effects.

The present disclosure discloses a method for manufacturing a high-reactivity polyphenylene sulfide resin, which can be simultaneously realized in a PPS polymerization process, and that is to say, an end-capping reagent is not required to be additionally added to affect the molecular weight and thermal stability of the finally prepared PPS; and chain expansion treatment is also not required to be performed after the PPS resin is prepared to additionally increase the technological process and the production cost.

The high-reactivity polyphenylene sulfide resin prepared by the present disclosure has a carboxyl content of equal to or greater than 100 mmol/kg, more preferably, 150-250 mmol/kg. Meanwhile, the high-reactivity polyphenylene sulfide resin has both a high molecular weight and high thermal stability.

### DESCRIPTION OF THE EMBODIMENTS

In order to make the purposes, technical schemes and effects of the present disclosure clearer and more specific, the present disclosure is further described in detail below in combination with examples and attached drawings. However, it should be understood that the specific examples described herein are only used to explain the present disclosure and are not intended to limit the present disclosure.

Various properties of PPS resins prepared in various examples and comparative examples of the present disclosure are tested by the following methods.

Carboxyl content test: A PPS powder is melted and pressed by a hot press at 315° C. to prepare an amorphous film. An infrared spectrum is measured by a transmission method using a microscopic infrared spectrometer (Thermo Nicolet iN10, Thermo Scientific). Peak heights of absorption peaks of a sample at 1704 cm⁻¹ and 3065 cm⁻¹ are calculated to obtain corrected heights, recorded as H₃₀₆₅ and H₁₇₀₄, respectively. The carboxyl content is estimated according to the formula C═(H₁₇₀₄/H₃₀₆₅*4)/40/108.161*1000000.

Reactivity test: After 100 parts by mass of a PPS resin and 0.8 part by mass of 3-(2,3-epoxypropoxy) propyltrimethoxysilane are evenly mixed, the melt viscosity is measured by a melt viscosity measurement method described above. The viscosity rise is calculated as a ratio of the melt viscosity after adding a coupling agent to the melt viscosity before adding the coupling agent. A greater viscosity rise represents higher reactivity.

Molecular weight test: The weight-average molecular weight (M_{w}) of a polymer is measured by a high-temperature gel permeation chromatograph (GPC), and the weight-average molecular weight is calculated as a polystyrene conversion value. 1-chloronaphthalene is used as a solvent, the temperature is 210° C., and a UV detector (360 nm) is used as a detector.

Thermal stability: The melt viscosity of a polymer sample at 310° C. is measured by the melt viscosity measurement method. The melt viscosity at a heating and heat preservation time of 5 min and 30 min is measured, respectively, and the thermal stability is calculated as a ratio of the two. Details are as follows:

After the polymer sample is maintained at 310° C. for 5 min, the melt viscosity (MV₁) is measured at a shear velocity of 1,216 s⁻¹. After the same polymer sample is maintained at 310° C. for 30 min, the melt viscosity (MV₂) is measured at the shear velocity of 1,216 s⁻¹. Then, a ratio (MV₂/MV₁) is calculated based on the measured values, which is called a thermal stability index. A greater ratio represents that the polymer has higher thermal stability.

Melting temperature (Tₘ) test: The melting point of a PPS resin is measured by a differential scanning calorimeter (DSC). 2-3 mg of a PPS raw resin is heated to 340° C. at a heating rate of 10° C./min and then measured.

### Example 1

Dehydration: In a 100 L reactor, 24.80 kg (250.0 mol) of NMP, 11.00 kg (100.0 mol) of a 51.0 wt % sodium hydrosulfide aqueous solution, 7.74 kg (102.5 mol) of a 53.0 wt % sodium hydroxide aqueous solution and 2.00 kg (6.45 mol) of a 40.0 wt % sodium valerate aqueous solution were added. After air in the reactor was replaced with nitrogen, heating was performed at a rate of 1.0° C./min at a stirring speed of 130 rpm. When the temperature was raised to 195° C. until the water content in the reaction system was less than 1.1 mol/mol of sulfur, a dehydration process was completed. At this time, 10.18 kg of a solution was removed in the reactor (water content: 98.0 wt %, remaining: 2.0 wt % of NMP). The loss amount of hydrogen sulfide was calculated as 1.5 mol by a test. At this time, a sulfur source in the reactor was 98.5 mol, and a molar ratio of water to sulfur was 1.08.

Polymerization: When a mixture was cooled to 170° C., 14.85 kg (100.5 mol) of PDCB and 15.02 kg of NMP were added to the reactor, where a molar ratio of the PDCB to total sulfur was 1.02, and a molar ratio of the NMP to the total sulfur was 4. Heating was performed to 225° C. at a rate of 0.8° C./min for heat preservation for 2 hours, and heating was performed continuously (at 0.5° C./min) to 270° C. for heat preservation for 2 hours. The conversion rate of the PDCB was detected to be greater than 99%, and at this time, the molecular weight of a resin was almost not increased. Water that was 1.5 mol/mol of the sulfur source and was preheated to 80° C. was added through a high-pressure pump, and cooling was performed to 255° C. at a rate of 2.0° C./min for a continued reaction for 2 hours. After the reaction was completed, cooling was performed rapidly to 110° C., and the resin was filtered through a 150-mesh screen. The resin was separately washed with NMP, 0.3% diluted hydrochloric acid and water until the content of chloride ions was qualified, and then dried. Filtrates produced in washing processes were combined and collected, first subjected to azeotropic distillation to separate the sodium valerate, then subjected to distillation to remove the water, and finally subjected to reduced pressure distillation to recover the solvent NMP. A residue produced by the distillation was disposed by incineration.

According to tests, a PPS resin prepared in the present example has a melting temperature of 298.6° C. and an M_{w} value of 50,470. Other data are listed in Table 1 below.

### Example 2

A dehydration process was exactly the same as that in Example 1.

Polymerization: A preparation process at a polymerization stage was basically the same as that in Example 1, but was different in that after heat preservation was performed at 270° C. for 2 hours, water that was 1.5 mol/mol of a sulfur source was added through a high-pressure pump, and cooling was performed to 252° C. at a rate of 2.0° C./min for a continued reaction for 1.5 hours.

According to tests, a PPS resin prepared in the present example has a melting temperature of 299.3° C. and an M_{w} value of 51,630. Other data are listed in Table 1 below.

### Example 3

A dehydration process was exactly the same as that in Example 1.

Polymerization: A preparation process at a polymerization stage was basically the same as that in Example 1, but was different in that after heat preservation was performed at 270° C. for 2 hours, water that was 1 mol/mol of a sulfur source was added through a high-pressure pump, and cooling was performed to 258° C. at a rate of 2.0° C./min for a continued reaction for 1 hour.

According to tests, a PPS resin prepared in the present example has a melting temperature of 298.7° C. and an M_{w} value of 49,870. Other data are listed in Table 1 below.

### Example 4

A dehydration process was exactly the same as that in Example 1.

Polymerization: A preparation process at a polymerization stage was basically the same as that in Example 1, but was different in that after heat preservation was performed at 270° C. for 2 hours, water that was 2 mol/mol of a sulfur source was added through a high-pressure pump, and cooling was performed to 255° C. at a rate of 2.0° C./min for a continued reaction for 2 hours.

According to tests, a PPS resin prepared in the present example has a melting temperature of 298.9° C. and an M_{w} value of 49,760. Other data are listed in Table 1 below.

### Example 5

A dehydration process was exactly the same as that in Example 1.

Polymerization: A preparation process at a polymerization stage was basically the same as that in Example 1, but was different in that after heat preservation was performed at 270° C. for 2 hours, water that was 2.5 mol/mol of a sulfur source was added through a high-pressure pump, and cooling was performed to 250° C. at a rate of 2.0° C./min for a continued reaction for 3 hours.

According to tests, a PPS resin prepared in the present example has a melting temperature of 299.1° C. and an M_{w} value of 48,430. Other data are listed in Table 1 below.

### Example 6

A dehydration process was exactly the same as that in Example 1.

Polymerization: A preparation process at a polymerization stage was basically the same as that in Example 1, but was only different in that after water that was 1.5 mol/mol of a sulfur source was added through a high-pressure pump, cooling was performed to 255° C. at a rate of 1.0° C./min for a continued reaction for 2 hours.

According to tests, a PPS resin prepared in the present example has a melting temperature of 298.5° C. and an M_{w} value of 48,560. Other data are listed in Table 1 below.

### Example 7

A dehydration process was exactly the same as that in Example 1.

Polymerization: A preparation process at a polymerization stage was basically the same as that in Example 1, but was only different in that after water that was 1.5 mol/mol of a sulfur source was added through a high-pressure pump, cooling was performed to 260° C. at 3.0° C./min for a continued reaction for 1 hour.

According to tests, a PPS resin prepared in the present example has a melting temperature of 297.9° C. and an M_{w} value of 46,760. Other data are listed in Table 1 below.

### Example 8

A dehydration process was exactly the same as that in Example 1.

Polymerization: At a polymerization stage, same proportions of raw material were added to a reactor as that in Example 1. Heating was performed to 225° C. at a rate of 0.6° C./min for heat preservation for 2 hours, and heating was performed continuously (at 0.5° C./min) to 270° C. for heat preservation for 1.5 hours. The conversion rate of PDCB was detected to be greater than 97%. Water that was 1.5 mol/mol of a sulfur source and was preheated to 80° C. was added through a high-pressure pump, and cooling was performed to 255° C. at a rate of 2.0° C./min for a continued reaction for 2 hours.

According to tests, a PPS resin prepared in the present example has a melting temperature of 297.5° C. and an M_{w} value of 35,680. Other data are listed in Table 1 below.

### Comparative Example 1

A dehydration process was exactly the same as that in Example 1.

Polymerization: A preparation process at a polymerization stage was basically the same as that in Example 1, but was different in that after heat preservation was performed at 270° C. for 2 hours, water was not added, and only cooling was performed to 255° C. for a continued reaction for 2 hours.

According to tests, a PPS resin prepared in the present comparative example has a melting temperature of 299.4° C. and an M_{w} value of 43,260. Other data are listed in Table 1 below.

### Comparative Example 2

A dehydration process was exactly the same as that in Example 1.

Polymerization: A preparation process at a polymerization stage was basically the same as that in Example 1, but was only different in that after water that was 1.5 mol/mol of a sulfur source was added through a high-pressure pump, cooling was performed to 240° C. at a rate of 2.0° C./min for a continued reaction for 1.5 hours.

According to tests, a PPS resin prepared in the present comparative example has a melting temperature of 299.2° C. and an M_{w} value of 46,640. Other data are listed in Table 1 below.

### Comparative Example 3

A dehydration process was exactly the same as that in Example 1.

Polymerization: At a polymerization stage, same proportions of raw material were added to a reactor as that in Example 1. Heating was performed to 225° C. at a rate of 1.5° C./min for heat preservation for 2 hours, water that was 1.5 mol/mol of a sulfur source and was preheated to 80° C. was added through a high-pressure pump, and heating was performed continuously (at 0.5° C./min) to 270° C. for heat preservation for 2 hours. The conversion rate of PDCB was detected to be greater than 99%. After the heat preservation was completed, cooling was performed to 253° C. at a rate of 3.0° C./min for a continued reaction for 1.5 hours.

According to tests, a PPS resin prepared in the present comparative example has a melting temperature of 298.5° C. and an M_{w} value of 47,680. Other data are listed in Table 1 below.

### Comparative Example 4

A dehydration process was exactly the same as that in Example 1.

Polymerization: A preparation process at a polymerization stage was basically the same as that in Example 1, but was only different in that after water that was 1.5 mol/mol of a sulfur source was added through a high-pressure pump, cooling was performed to 255° C. at a rate of 0.5° C./min for a continued reaction for 2 hours.

According to tests, a PPS resin prepared in the present comparative example has a melting temperature of 296.5° C. and an M_{w} value of 37,620. Other data are listed in Table 1 below.

### Comparative Example 5

A dehydration process was exactly the same as that in Example 1.

Polymerization: A preparation process at a polymerization stage was basically the same as that in Example 1, but was only different in that water that was 0.5 mol/mol of a sulfur source was added through a high-pressure pump.

According to tests, a PPS resin prepared in the present comparative example has a melting temperature of 299.5° C. and an M_{w} value of 51,380. Other data are listed in Table 1 below.

### Comparative Example 6

A dehydration process was exactly the same as that in Example 1.

Polymerization: A preparation process at a polymerization stage was basically the same as that in Example 1, but was only different in that water that was 3.0 mol/mol of a sulfur source was added through a high-pressure pump.

According to tests, a PPS resin prepared in the present comparative example has a melting temperature of 297.8° C. and an M_{w} value of 48,610. Other data are listed in Table 1 below.

TABLE 1

| | | | | End- | | | | |
|---|---|---|---|---|---|---|---|---|
| | | Water | | capping | End- | | | |
| | | addition | Cooling | reaction | capping | Carboxyl | | |
| | Water | amount/mol/ | rate/ | temperature/ | reaction | content/ | Thermal | |
| Number | addition time | mol S source | ° C./min | ° C. | time/h | mmol/kg | stability | Reactivity |
| Example 1 | Completion | 1.5 | 2.0 | 255 | 2 | 198 | 0.87 | 4.31 |
| | of heat | | | | | | | |
| | preservation | | | | | | | |
| | at 270° C. | | | | | | | |
| | for 2 h | | | | | | | |
| Example 2 | Completion | 1.5 | 2.0 | 252 | 1.5 | 152 | 0.89 | 3.35 |
| | of heat | | | | | | | |
| | preservation | | | | | | | |
| | at 270° C. | | | | | | | |
| | for 2 h | | | | | | | |
| Example 3 | Completion | 1.0 | 2.0 | 258 | 1 | 104 | 0.86 | 2.76 |
| | of heat | | | | | | | |
| | preservation | | | | | | | |
| | at 270° C. | | | | | | | |
| | for 2 h | | | | | | | |
| Example 4 | Completion | 2.0 | 2.0 | 255 | 2 | 235 | 0.83 | 5.43 |
| | of heat | | | | | | | |
| | preservation | | | | | | | |
| | at 270° C. | | | | | | | |
| | for 2 h | | | | | | | |
| Example 5 | Completion | 2.5 | 2.0 | 250 | 3 | 203 | 0.82 | 5.56 |
| | of heat | | | | | | | |
| | preservation | | | | | | | |
| | at 270° C. | | | | | | | |
| | for 2 h | | | | | | | |
| Example 6 | Completion | 1.5 | 1.0 | 255 | 2 | 210 | 0.78 | 4.52 |
| | of heat | | | | | | | |
| | preservation | | | | | | | |
| | at 270° C. | | | | | | | |
| | for 2 h | | | | | | | |
| Example 7 | Completion | 1.5 | 3.0 | 260 | 1 | 170 | 0.75 | 3.52 |
| | of heat | | | | | | | |
| | preservation | | | | | | | |
| | at 270° C. | | | | | | | |
| | for 2 h | | | | | | | |
| Example 8 | Completion | 1.5 | 2.0 | 255 | 2 | 180 | 0.84 | 4.12 |
| | of heat | | | | | | | |
| | preservation | | | | | | | |
| | at 270° C. | | | | | | | |
| | for 1.5 h | | | | | | | |
| Comparative | \ | \ | \ | 255 | 2 | 43 | 0.86 | 1.93 |
| Example 1 | | | | | | | | |
| Comparative | Completion | 1.5 | 2.0 | 240 | 1.5 | 51 | 0.87 | 2.28 |
| Example 2 | of heat | | | | | | | |
| | preservation | | | | | | | |
| | at 270° C. | | | | | | | |
| | for 2 h | | | | | | | |
| Comparative | Completion | 1.5 | 3.0 | 253 | 1.5 | 48 | 0.83 | 2.07 |
| Example 3 | of heat | | | | | | | |
| | preservation | | | | | | | |
| | at 225° C. | | | | | | | |
| | for 2 h | | | | | | | |
| Comparative | Completion | 1.5 | 0.5 | 255 | 2 | 120 | 0.67 | 3.31 |
| Example 4 | of heat | | | | | | | |
| | preservation | | | | | | | |
| | at 270° C. | | | | | | | |
| | for 2 h | | | | | | | |
| Comparative | Completion | 0.5 | 2.0 | 255 | 2 | 70 | 0.89 | 2.56 |
| Example 5 | of heat | | | | | | | |
| | preservation | | | | | | | |
| | at 270° C. | | | | | | | |
| | for 2 h | | | | | | | |
| Comparative | Completion | 3.0 | 2.0 | 255 | 2 | 154 | 0.65 | 3.22 |
| Example 6 | of heat | | | | | | | |
| | preservation | | | | | | | |
| | at 270° C. | | | | | | | |
| | for 2 h | | | | | | | |

Results of Comparative Example 2 and Comparative Example 3 show that after the deionized water is added, both the reaction temperature and the deionized water addition time will have a great impact on the carboxyl content and the reactivity. Results of Comparative Example 6 show that compared with the addition of water that was 1.5 mol/mol (Example 1) or 2.0 mol/mol (Example 4) of the sulfur source, the addition of water that was 3.0 mol/mol of the sulfur source reduces the carboxyl content, the thermal stability and the reactivity, especially obviously reduces the thermal stability.

1. A method for manufacturing a high-reactivity polyphenylene sulfide resin, wherein the method comprises: carrying out a polycondensation reaction with sodium hydrosulfide and p-dichlorobenzene as raw materials and N-methyl-2-pyrrolidone as a solvent until a conversion rate of the p-dichlorobenzene reaches 97% or above, adding deionized water, reducing the temperature in a reactor to 250-260° C. for a heat preservation reaction for 1-3 hours, and performing cooling for post-treatment;
and calculated with the content of total sulfur in the system as 1.0 mol, a molar amount of the added deionized water is 1.0-2.5 mol.

2. The method for manufacturing a high-reactivity polyphenylene sulfide resin according to claim 1, wherein:
the deionized water is added when the polycondensation reaction is carried out until the conversion rate of the p-dichlorobenzene reaches 99% or above; and the temperature in the reactor is reduced to 250-260° C. at a cooling rate of 1.0-3.0° C./min.

3. The method for manufacturing a high-reactivity polyphenylene sulfide resin according to claim 1, specifically comprising:
(1) putting a sodium hydrosulfide aqueous solution, an alkali metal hydroxide aqueous solution, an optionally added additive and N-methyl-2-pyrrolidone into a reactor, performing heating to 180-200° C. for dehydration under the protection of a nitrogen atmosphere, and then performing cooling to 160-180° C.;
(2) adding p-dichlorobenzene and N-methyl-2-pyrrolidone to the reactor, performing heating to 220-240° C. to carry out a polymerization reaction first until the conversion rate of the p-dichlorobenzene reaches 85% or above, and then performing heating to 260-280° C. to carry out the polymerization reaction; and
(3) adding deionized water to the reactor, reducing the temperature in the reactor to 250-260° C. for a heat preservation reaction for 1-3 h, performing cooling to 100-150° C. to obtain a PPS reaction solution, and then performing post-treatment to obtain high-reactivity polyphenylene sulfide.

4. The method for manufacturing a high-reactivity polyphenylene sulfide resin according to claim 3, wherein in step (1):
a concentration of the sodium hydrosulfide aqueous solution is 40-55 wt %, and a concentration of the alkali metal hydroxide aqueous solution is 45-55 wt %;
calculated with NaHS in the sodium hydrosulfide aqueous solution as 1.0 mol, a molar amount of an alkali metal hydroxide is 1.0-1.4 mol;
the optionally added additive is selected from a C₅-C₆ fatty acid salt and added in the form of a 35-45 wt % aqueous solution, and calculated with NaHS in the sodium hydrosulfide aqueous solution as 1.0 mol, a molar amount of the added additive is 0.1-0.5 mol;
and calculated with NaHS in the sodium hydrosulfide aqueous solution as 1.0 mol, a molar amount of the added N-methyl-2-pyrrolidone is 2.4-3.0 mol.

5. The method for manufacturing a high-reactivity polyphenylene sulfide resin according to claim 3, wherein in step (1):
the heating is performed to 180-200° C. for the dehydration at a heating rate of 0.7-1.5° C./min;
and the dehydration is performed until a molar content ratio of water to sulfur in the system is (0.9-1.2):1.

6. The method for manufacturing a high-reactivity polyphenylene sulfide resin according to claim 3, wherein in step (2):
calculated with the content of total sulfur in the system as 1.0 mol, a molar amount of the p-dichlorobenzene is 0.99-1.05 mol;
after the N-methyl-2-pyrrolidone is added, calculated with the content of total sulfur in the system as 1.0 mol, a molar amount of the N-methyl-2-pyrrolidone in the system is 3.5-4.5 mol;
and the heating is performed to 220-240° C. at a heating rate of 0.6-1.5° C./min to carry out the polymerization reaction first, and then the heating is performed to 260-280° C. at a heating rate of 0.5-1.0° C./min to carry out the polymerization reaction.

7. The method for manufacturing a high-reactivity polyphenylene sulfide resin according to claim 3, wherein in step (3):
calculated with the content of total sulfur in the system as 1.0 mol, a molar amount of the added deionized water is 1.0-2.5 mol;
and after the temperature in the reactor is reduced to 250-260° C. at a cooling rate of 1.0-3.0° C./min, the heat preservation reaction is carried out for 1-3 hours.

8. The method for manufacturing a high-reactivity polyphenylene sulfide resin according to claim 3, wherein in step (3):
the post-treatment comprises filtering, washing, and drying.

9. A high-reactivity polyphenylene sulfide resin prepared by the method according to claim 1, wherein the high-reactivity polyphenylene sulfide resin has a carboxyl content of equal to or greater than 100 mmol/kg.

10. The high-reactivity polyphenylene sulfide resin according to claim 9, wherein the high-reactivity polyphenylene sulfide resin has the carboxyl content of 150-250 mmol/kg.

11. The method for manufacturing a high-reactivity polyphenylene sulfide resin according to claim 2, specifically comprising:
(1) putting a sodium hydrosulfide aqueous solution, an alkali metal hydroxide aqueous solution, an optionally added additive and N-methyl-2-pyrrolidone into a reactor, performing heating to 180-200° C. for dehydration under the protection of a nitrogen atmosphere, and then performing cooling to 160-180° C.;
(2) adding p-dichlorobenzene and N-methyl-2-pyrrolidone to the reactor, performing heating to 220-240° C. to carry out a polymerization reaction first until the conversion rate of the p-dichlorobenzene reaches 85% or above, and then performing heating to 260-280° C. to carry out the polymerization reaction; and
(3) adding deionized water to the reactor, reducing the temperature in the reactor to 250-260° C. for a heat preservation reaction for 1-3 h, performing cooling to 100-150° C. to obtain a PPS reaction solution, and then performing post-treatment to obtain high-reactivity polyphenylene sulfide.

12. The method for manufacturing a high-reactivity polyphenylene sulfide resin according to claim 11, wherein in step (1):
a concentration of the sodium hydrosulfide aqueous solution is 40-55 wt %, and a concentration of the alkali metal hydroxide aqueous solution is 45-55 wt %;
calculated with NaHS in the sodium hydrosulfide aqueous solution as 1.0 mol, a molar amount of an alkali metal hydroxide is 1.0-1.4 mol;
the optionally added additive is selected from a C₅-C₆ fatty acid salt and added in the form of a 35-45 wt % aqueous solution, and calculated with NaHS in the sodium hydrosulfide aqueous solution as 1.0 mol, a molar amount of the added additive is 0.1-0.5 mol;
and calculated with NaHS in the sodium hydrosulfide aqueous solution as 1.0 mol, a molar amount of the added N-methyl-2-pyrrolidone is 2.4-3.0 mol.

13. The method for manufacturing a high-reactivity polyphenylene sulfide resin according to claim 11, wherein in step (1):
the heating is performed to 180-200° C. for the dehydration at a heating rate of 0.7-1.5° C./min;
and the dehydration is performed until a molar content ratio of water to sulfur in the system is (0.9-1.2):1.

14. The method for manufacturing a high-reactivity polyphenylene sulfide resin according to claim 11, wherein in step (2):
calculated with the content of total sulfur in the system as 1.0 mol, a molar amount of the p-dichlorobenzene is 0.99-1.05 mol;
after the N-methyl-2-pyrrolidone is added, calculated with the content of total sulfur in the system as 1.0 mol, a molar amount of the N-methyl-2-pyrrolidone in the system is 3.5-4.5 mol;
and the heating is performed to 220-240° C. at a heating rate of 0.6-1.5° C./min to carry out the polymerization reaction first, and then the heating is performed to 260-280° C. at a heating rate of 0.5-1.0° C./min to carry out the polymerization reaction.

15. The method for manufacturing a high-reactivity polyphenylene sulfide resin according to claim 11, wherein in step (3):
calculated with the content of total sulfur in the system as 1.0 mol, a molar amount of the added deionized water is 1.0-2.5 mol;
and after the temperature in the reactor is reduced to 250-260° C. at a cooling rate of 1.0-3.0° C./min, the heat preservation reaction is carried out for 1-3 hours.

16. The method for manufacturing a high-reactivity polyphenylene sulfide resin according to claim 11, wherein in step (3):
the post-treatment comprises filtering, washing, and drying.
